(19) United States
(12) Patent Application Publication
(10) Pub. No.: US 2018/0191163 A1
(43) Pub. Date: Jul. 5, 2018

(54) POWER GENERATION FACILITY AND METHOD FOR THE OPERATION THEREOF

(71) Applicant: SIEMENS AKTIENGESELLSCHAFT, München (DE)

(72) Inventors: TIMO CHRIST, GRAEFENBERG (DE); SLAVOMIR SEMAN, ROSSTAL (DE); RAINER ZUROWSKI, FORCHHEIM (DE)

(21) Appl. No.: 15/741,777

(22) PCT Filed: Jun. 9, 2016
(86) PCT No.: PCT/EP2016/063176

§ 371 Date: Jan. 4, 2018

(30) Foreign Application Priority Data
Jul. 6, 2015 (DE) 10 2015 212 562.9

(51) Int. Cl. H02J 3/36; H02J 3/38; F03D 9/25; F03D 7/02

(52) U.S. Cl. CPC H02J 3/36; F03D 7/0272; F03D 9/257; H02J 3/386

(57) ABSTRACT

A power generation facility includes at least one generator which has a converter on the generator side and a converter on the network side and which is connected by the converters to an alternating voltage network on the power plant side. A rectifier connects the alternating voltage network on the power plant side to a DC transmission line. An inverter on the energy network side connects the DC transmission line to an energy network operating on the basis of alternating voltage. A control unit is configured to control the converter on the generator side and the converter on the network side of the at least one generator, at least on the basis of DC current and/or DC voltage measurement values measured on the DC transmission line. A method for operating a power generation facility is also provided.

The present invention relates to a power generation facility including at least one generator which has a generator-side converter and a network-side converter and is connected via said converters to a power plant-side AC-voltage network, a rectifier which connects the power-plant side AC-voltage network to a direct-current transmission line, and a power grid-side inverter which connects the direct-current transmission line to a power grid operating based on AC voltage. It is known that such power generation facilities having a power-plant side AC-voltage network and a direct-current transmission line are, for example, in operation as wind power facilities.

In conventional power generation facilities, the problem of fluctuating power consumption by the power grid is solved in that connectable power consumption devices and/or connectable energy storage devices are connected to the direct-current transmission line, said devices being connected as necessary or in the case of insufficient power consumption by the power grid, and thus enabling additional power consumption and/or additional energy storage in the area of the direct-current transmission line.

The object of the present invention is to provide a power generation facility which functions better than conventional power generation facilities in the case of fluctuations in the power consumption of the power grid.

This object is achieved according to the present invention by a power generation facility having the features as claimed in patent claim 1. Advantageous embodiments of the power generation facility according to the present invention are provided in the subclaims.

Thus, according to the present invention, it is provided that the power generation facility includes a control device which is designed in such a way that it carries out the control of the generator-side converter and the network-side converter of the at least one generator at least also based on direct-current and/or DC-voltage measurement values which are measured on the direct-current transmission line.

A significant advantage of the power generation facility according to the present invention may be seen in the fact that by means of the direct control of the network-side converters and the generator-side converters which are provided according to the present invention, the power generation by means of the generators and thus the power feed into the power-plant side AC-voltage network may be readjusted in a timely manner, so that the overgeneration of power by the generators and an excessive feed of power into the power-plant side AC-voltage network are prevented. Therefore, it is possible to eliminate the use of connectable power consumption devices and/or connectable energy storage devices as are present in previously known power generation facilities.

With respect to the embodiment of the control device, it is considered to be advantageous if said control device additionally takes into consideration alternating-current and/or AC-voltage measurement values which are measured on the power grid, when controlling the generator-side converter and the network-side converter of the at least one generator.

The rectifier is preferably a diode bridge rectifier.

In addition, the control device is preferably designed in such a way that it ascertains the power consumed by the power grid, based on the direct-current and/or DC-voltage measurement values which are measured on the direct-current transmission line, and the alternating-current and/or AC-voltage measurement values which are measured on the power grid, and in the case of exceeding a predefined minimum power value, controls the generator-side converter and the network-side converter of the at least one generator in such a way that said generator feeds less power, in particular no more power, into the power-plant side AC-voltage network, and/or the rectifier is brought into a non-conductive state.

With a view to minimizing costs of the power generation facility, it is considered to be advantageous if the direct-current transmission line is free of connectable power consumption devices and/or energy storage devices. As already mentioned, by means of the functioning of the control device, power consumption devices and/or energy storage devices in the area of the direct-current transmission line may be eliminated.

In addition, it is advantageous if the power generation facility includes a plurality of generators which are respectively connected to the power-plant side AC-voltage network via a separate generator-side converter and a separate network-side converter, and the control device is designed in such a way that it carries out the control of the generator-side converters and the network-side converters at least also based on the direct-current measurement values and/or DC-voltage measurement values which are measured on the direct-current transmission line.

Advantageously, the control device is designed in such a way that it additionally also takes into consideration the alternating-current and/or AC-voltage measurement values which are respectively measured on the power grid, when controlling the generator-side converters and the network-side converters.

The power transmission facility is preferably a wind power facility; in this case, the generators are formed by wind turbines.

With respect to the connection between the control device and the converters of the generators, it is considered to be advantageous if the control device is connected to the generator-side converter(s) and the network-side converter(s) via one or multiple optical waveguides, and transmits control signals via said optical waveguide(s) for controlling the generator-side converter(s) and the network-side converter(s).

With respect to the arrangement of the individual components of the power generation facility, it is considered to be particularly advantageous if the generator(s) are positioned at sea and the power grid-side inverter is located on land.

The power grid is preferably a power distribution grid or a power transmission grid.

The present invention also relates to a method for operating a power generation facility including at least one generator which is connected to a power-plant side AC-voltage network via a generator-side converter and a network-side converter, a rectifier which connects the power-plant side AC-voltage network to a direct-current transmission line, and a power grid-side inverter which connects the direct-current transmission line to a power grid operating based on AC voltage.

According to the present invention, with respect to such a method, it is provided that the control of the generator-side converter and the network-side converter is carried out at least also based on direct-current and/or DC-voltage measurement values which are measured on the direct-current transmission line.

With respect to the advantages of the method according to the present invention, reference will be made to the above descriptions in conjunction with the power generation facility according to the present invention.

The present invention will be described in greater detail below based on exemplary embodiments; the following are shown by way of example:

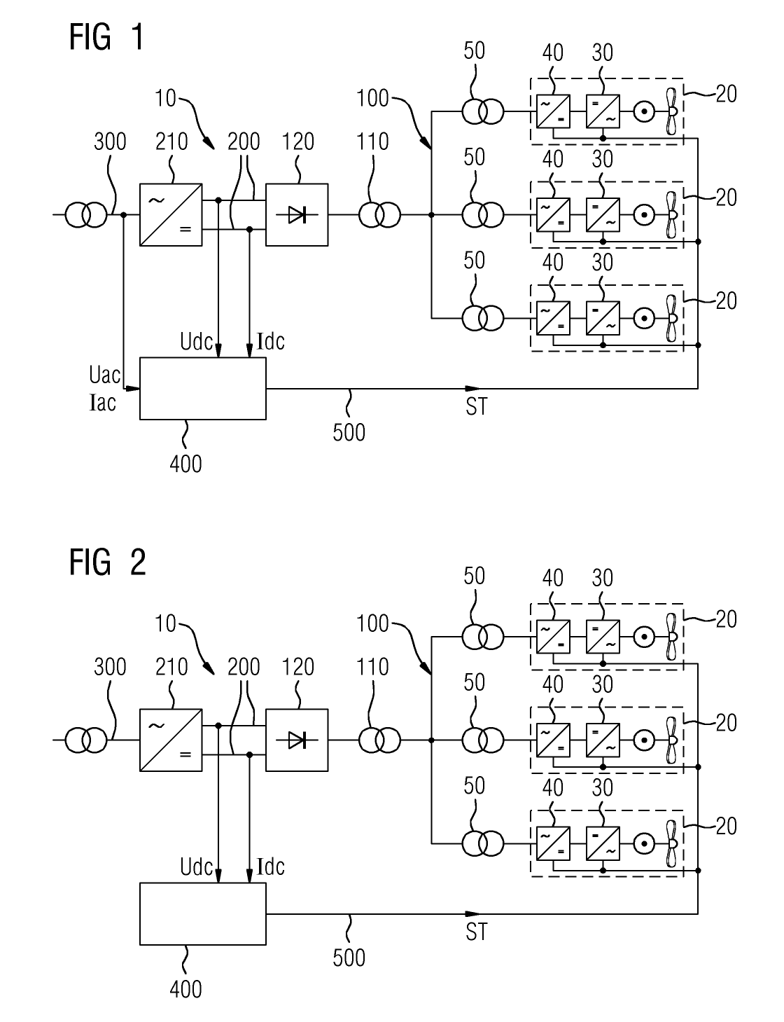

FIG. 1 shows an exemplary embodiment of a power generation facility according to the present invention, on the basis of which a method variant according to the present invention is also explained by way of example; and

FIG. 2 shows an additional exemplary embodiment of a power generation facility according to the present invention, on the basis of which another method variant is described by way of example.

FIG. 1 shows a power generation facility 10 which comprises a plurality of generators in the form of wind turbines 20. Each of the wind turbines 20 is equipped with a generator-side converter 30 and a network-side converter 40 and is connected via these components and a transformer 50 to a power-plant side AC-voltage network 100.

The power-plant side AC-voltage network 100 is connected via a transformer 110 and a rectifier 120 to a high-voltage direct-current transmission line, referred to below in short as direct-current transmission line. The rectifier 120 is preferably a diode bridge rectifier.

The direct-current transmission line 200 connects the rectifier 120 and thus the power-plant side AC-voltage network 100 to a power grid-side high-voltage inverter, referred to below in short as power grid-side inverter 210, which establishes a connection to an external power grid 300. The power grid 300 may be a power distribution network or a power transmission network. The power grid 300 preferably operates at a voltage of 220 kV, 380 kV, 500 kV, 700 kV, or 1150 kV.

To control the power generation facility 10, a control device 400 is present which is connected via measurement devices to the direct-current transmission line 200 and the power grid 300.

Via the measuring devices, the control device 400 receives direct-current measurement values Idc and DC-voltage measurement values Udc, which respectively quantitatively specify the direct current flowing through the direct-current transmission line 200 and the DC voltage applied to the direct-current transmission line 200.

From the power grid 300, the control device 400 receives AC-voltage measurement values Uac and alternating-current measurement values Iac, which quantitatively describe the AC voltage and the alternating current in the power grid 300 and thus the power flow into the power grid 300.

The control device 400 is configured in such a way that it evaluates the direct-current and DC-voltage measurement values Idc and Udc, and the alternating-current and AC-voltage measurement values Iac and Uac, and based on the measurement values, carries out the control of the generator-side converters 30 and the network-side converters 40.

The control of the generator-side converters 30 and the network-side converters 40 takes place in the exemplary embodiment according to FIG. 1 by means of control signals ST which are transmitted via a data line 500 to the generator-side converters 30 and the network-side converters 40. The data line 500 is preferably an optical waveguide-based data line which comprises one or more optical waveguides for data transmission.

Within the scope of the control of the generator-side converters 30 and the network-side converters 40, the control device 400 will preferably ascertain how much power the power grid 300 is instantaneously consuming in each case. If the control device 400 determines that the power consumed by the power grid 300 is too little and the power production of the wind turbines 20 is too great, it will control the generator-side converters 30 and the network-side converters 40 in such a way that they feed less power, in particular no more power, into the power-plant side AC-voltage network 100. For example, the control of the converters 30 and 40 may take place in such a way that the rectifier 120 is brought into a non-conductive state, and as a result, the direct-current transmission line 200 is electrically disconnected from the power-plant side AC-voltage network 100.

By means of the direct control of the generator-side converters 30 and the network-side converters 40 based on measurement values which relate to the power grid 300 and the direct-current transmission line 200, the control of the power generation facility 10 may take place with very little delay, so that power production by the wind turbines 20 can be prevented. Connectable power consumption devices and/or connectable energy storage devices, which would generally otherwise be required in the area of the power-plant side AC-voltage network and/or the direct-current transmission line 200, may thus be eliminated in the power generation facility 10 due to the functioning of the control device 400.

FIG. 2 shows an additional exemplary embodiment of a power generation facility 10 according to the present invention. In this exemplary embodiment, the control device 400 evaluates only the direct-current measurement values Idc and the DC-voltage measurement values Udc, which respectively specify the direct current flowing through the direct-current transmission line 200 and the DC voltage applied to the direct-current transmission line 200, and controls the generator-side converters 30 and the network-side converters 40 based only on these measurement values.

Moreover, the above explanations in conjunction with FIG. 1 correspondingly apply to the exemplary embodiment according to FIG. 2.

Although the present invention has been illustrated and described in greater detail via preferred exemplary embodiments, the present invention is not limited by the disclosed examples, and other variations may be derived from it by those skilled in the art, without departing from the protective scope of the present invention.

### LIST OF REFERENCE CHARACTERS

10 Power generation facility
20 Wind turbines/generators
30 Generator-side converter
40 Network-side converter
50 Transformer
100 AC-voltage network
110 Transformer
120 Rectifier
200 Direct-current transmission line
210 Inverter
300 Power grid
400 Control device
500 Data line
Iac Alternating-current measurement values
Idc Direct-current measurement values
ST Control signals
Uac AC-voltage measurement values
Udc DC-voltage measurement values

1-13. (canceled)

14. A power generation facility, comprising:
a power-plant side AC-voltage network;
at least one generator having a generator-side converter and a network-side converter, said at least one generator being connected by said converters to said power-plant side AC-voltage network;
a direct-current transmission line;
a rectifier connecting said power-plant side AC-voltage network to said direct-current transmission line;
a power grid-side inverter connecting said direct-current transmission line to a power grid operating on a basis of AC voltage; and
a control device configured to control said generator-side converter and said network-side converter of said at least one generator at least based on at least one of direct-current or DC-voltage measurement values being measured on said direct-current transmission line.

15. The power generation facility according to claim 14, wherein said control device is configured to additionally take into consideration at least one of alternating-current or AC-voltage measurement values being measured on the power grid, when controlling said generator-side converter and said network-side converter of said at least one generator.

16. The power generation facility according to claim 14, wherein said rectifier is a diode bridge rectifier.

17. The power generation facility according to claim 14, wherein:
said control device is configured to ascertain power consumed by the power grid, based on the at least one of direct-current or DC-voltage measurement values being measured on said direct-current transmission line, and the at least one of alternating-current or AC-voltage measurement values being measured on the power grid; and
upon exceeding a predefined minimum power value, said control device is configured to control said generator-side converter and said network-side converter of said at least one generator to at least one of cause said generator to feed less power or no more power into said power-plant side AC-voltage network or bring said rectifier into a non-conductive state.

18. The power generation facility according to claim 14, wherein said direct-current transmission line is free of at least one of connectable power consumption devices or energy storage devices.

19. The power generation facility according to claim 14, wherein:
said at least one generator includes a plurality of generators each being respectively connected to said power-plant side AC-voltage network through a separate generator-side converter and a separate network-side converter; and
said control device is configured to control said generator-side converters and said network-side converters at least based on at least one of the direct-current or DC-voltage measurement values being measured on said direct-current transmission line.

20. The power generation facility according to claim 19, wherein said control device is configured to additionally take into consideration at least one of the alternating-current or AC-voltage measurement values being respectively measured on the power grid, when controlling said generator-side converters and said network-side converters.

21. The power generation facility according to claim 14, wherein the power generation facility is a wind power facility and said generators are wind turbines.

22. The power generation facility according to claim 14, which further comprises at least one optical waveguide connecting said control device to said generator-side converter and said network-side converter, said control device transmitting control signals over said at least one optical waveguide for controlling said generator-side converter and said network-side converter.

23. The power generation facility according to claim 14, wherein said generator is positioned at sea and said power grid-side inverter is located on land.

24. The power generation facility according to claim 14, wherein the power grid is a power transmission network.

25. The power generation facility according to claim 14, wherein the power grid is a power distribution network.

26. A method for operating a power generation facility, the method comprising the following steps:
providing at least one generator being connected to a power-plant side AC-voltage network by a generator-side converter and a network-side converter;
providing a rectifier connecting the power-plant side AC-voltage network to a direct-current transmission line;
providing a power grid-side inverter connecting the direct-current transmission line to a power grid operating on a basis of AC voltage; and
controlling the generator-side converter and the network-side converter at least based on at least one of direct-current or DC-voltage measurement values being measured on the direct-current transmission line.
